(19) United States
(12) Patent Application Publication
(10) Pub. No.: US 2006/0187127 A1
(43) Pub. Date: Aug. 24, 2006

(54) TRANSCEIVING APPARATUS CAPABLE OF ADJUSTING TRANSCEIVING DIRECTION

(76) Inventor: Hua-Chung Tseng, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/307,586

(22) Filed: Feb. 14, 2006

(30) Foreign Application Priority Data
Feb. 23, 2005 (TW) 094105454

(51) Int. Cl. H01Q 1/24

(52) U.S. Cl. 343/702; 343/906

(57) ABSTRACT

A transceiving apparatus capable of adjusting a transceiving direction is disclosed. The transceiving apparatus includes a signal transceiving component for transmitting or receiving a signal; and a holder connected to an electronic device in a rotatable position, wherein the signal transceiving component is installed in the holder.

### BACKGROUND OF THE INVENTION

1. Field of the Invention

The present invention relates to a transceiving apparatus, and more specifically, to a transceiving apparatus capable of adjusting a transceiving direction.

2. Description of the Prior Art

Infrared ray (IR) transceiving modules are common devices in notebook computers. Users can transceive data between two notebook computers both containing IR transceiving modules. Or, after installing specific software in a notebook computer, the notebook computer can synchronize with a mobile phone or a personal digital assistant (PDA) containing an IR transceiving function to transceive data, Java applications or games. For example, a user can download mobile phone wallpapers or ring tones using a notebook computer, easily modify the mobile phone wallpapers or ring tones using the notebook computer, and then upload the modified mobile phone wallpapers or ring tones from the notebook computer to a mobile phone without paying any fee for messages or GPRS. A user can also edit their phone book or organizer, and then upload the phone book or organizer to their mobile phone to save time, while also saving a backup for the phone book or organizer in the notebook computer.

Utilization of the IR transceiving function has limitations, however; for example, when transceiving data, the transmitter and the receiver have to be in a straight line; if some object exists between the transmitter and the receiver, or the transceiving direction shifts, transceiving of data may fail.

### SUMMARY OF THE INVENTION

One of the objectives of the claimed invention is therefore to provide a transceiving apparatus capable of adjusting a transceiving direction to solve the above-mentioned problem.

Another objective of the claimed invention is to provide a connecting apparatus for adjusting a transceiving direction of the connecting apparatus, in order to solve the above-mentioned problem.

According to the claimed invention, a transceiving apparatus capable of adjusting a transceiving direction is disclosed. The transceiving apparatus comprises: a signal transceiving component for transmitting or receiving a signal; and a holder connected to an electronic device in a rotatable position, wherein the signal transceiving component is installed in the holder.

According to the claimed invention, a connecting apparatus is disclosed. The connecting apparatus comprises: a signal transceiving component for transmitting or receiving a signal; a first positioning component, wherein the signal transceiving component is connected to the first positioning component in a rotatable position; and a holder connected to an electronic device in a rotatable position, wherein the signal transceiving component and the first positioning component are installed in the holder.

According to the claimed invention, an electronic device is disclosed. The electronic device comprises: a housing; a signal transceiving component for transmitting or receiving a signal; and a holder connected to the housing in a rotatable position, wherein the signal transceiving component is installed in the holder.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of a transceiving apparatus according to an embodiment of the present invention.

FIG. 2 is a front view diagram of the holder and the positioning component shown in FIG. 1.

FIG. 3 is a front view diagram of a holder and a positioning component of another embodiment according to the present invention.

FIG. 4 is a diagram of the signal transceiving component and the positioning component shown in FIG. 1.

FIG. 5 is an exterior view diagram of the fabricated transceiving apparatus shown in FIG. 1 according to the present invention.

### DETAILED DESCRIPTION

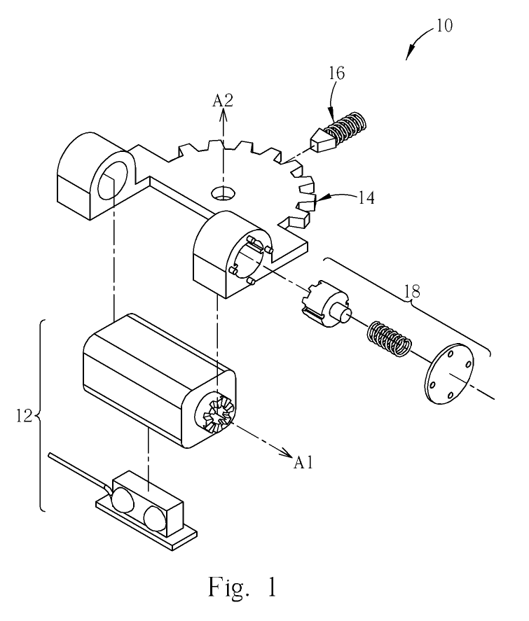

Please refer to FIG. 1. FIG. 1 is an exploded diagram of a transceiving apparatus 10 according to an embodiment of the present invention. The transceiving apparatus 10 can also be a connecting apparatus installed in an electronic device, such as a notebook computer. In the present embodiment, the transceiving apparatus 10 comprises a signal transceiving component 12, a holder 14, a positioning component 16, and another positioning component 18. The signal transceiving component 12 is an IR module for transmitting and receiving an IR signal. After manufacturing the transceiving apparatus 10, the signal transceiving component 12 is connected to the positioning component 18 in a rotatable position to limit the rotation angle generated by the signal transceiving component 12 rotating on the axle A1. The signal transceiving component 12 and the positioning component 18 are both installed in the holder 14. When the holder 14 rotates on the axle A2, the signal transceiving component 12 and the positioning component 18 rotate with the holder 14. Moreover, the holder 14 is connected to the positioning component 16 in a rotatable position, and the positioning component 16 can be utilized for limiting the rotation angle generated by the holder 14 rotating on the axle A2.

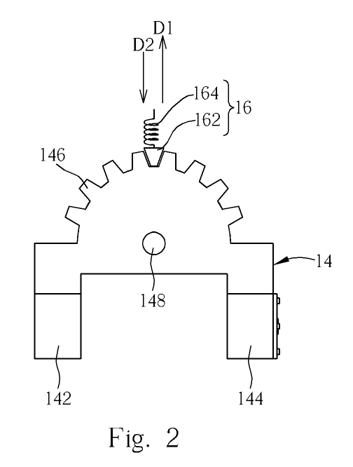

Please refer to FIG. 2 for a detailed description of the rotation of the signal transceiving component 12 shown in FIG. 1 rotating on the axle A2. FIG. 2 is a front view diagram of the holder 14 and the positioning component 16. The holder 14 comprises hinge parts 142 and 144, a gear part 146 and an axle hole 148. The hinge part 142 is utilized for installing the signal transceiving component 12 shown in FIG. 1 in a rotatable position. The hinge part 144 is utilized for holding the positioning component 18 shown in FIG. 1 to limit rotations of the signal transceiving component 12. The detailed description of the operation of the positioning component 18 will be included in the following. In the present embodiment, the axle hole 148 is fixed on a housing of an electronic device using a screw (not shown), and therefore the holder 14 can rotate relative to the electronic device around a rotation center—the axle hole 148. The gear part 146 is connected to the positioning component 16 in a rotatable position. The positioning component 16 connected to the housing of the above-mentioned electronic device comprises a wedge 162 and an elastic component 164. The elastic component 164 provides an elastic force towards a direction D2 to push the wedge 162 to connect with the gear part 146. When the holder 14 rotates, the gear part 146 pushes the wedge 162 to move in a direction D1 to repress the elastic component 164. When the holder 14 rotates by a predetermined angle, the spring 164 returns to the original state and pushes the wedge 162 to move towards the direction D2 to make the wedge 162 connect with the gear part 146 again, so that the rotation angle of the holder 14 is further limited. In this way, the holder 14 can rotate in a stepping way.

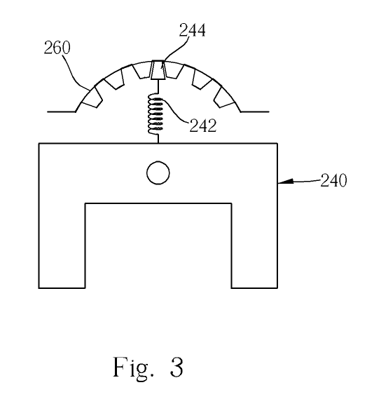

It should be noted that the holder and the positioning component connected to the holder are not limited to the forms utilized in the above-mentioned embodiment. Please refer to FIG. 3. FIG. 3 is a front view diagram of the holder 240 and the positioning component 260 of another embodiment according to the present invention. The holder 240 comprises an elastic component 242 and a wedge 244. The positioning component 260 is a concave gear fixed on a housing of an electronic device. In the same manner as before, when the holder 240 rotates, the elastic component 242 is repressed; when the holder 240 rotates by a predetermined angle, the elastic component 242 returns to the original state. In this way, the holder 240 can rotate relative to the electronic device.

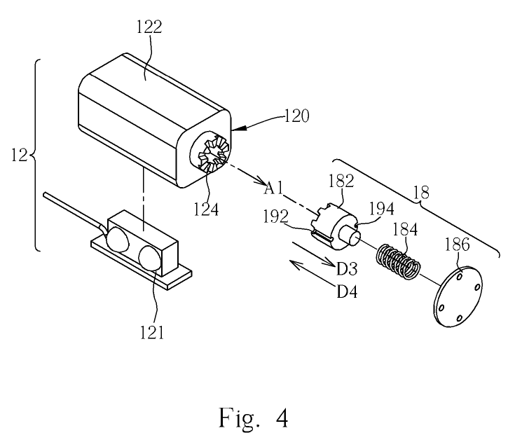

Please refer to FIG. 4 for a detailed description of the rotation of the signal transceiving component 12 shown in FIG. 1 rotating on the axle A1. FIG. 4 is a diagram of the signal transceiving component 12 and the positioning component 18 shown in FIG. 1. The signal transceiving component 12 comprises a component housing 120 and a signal processing circuit 121. The component housing 120 comprises a main part 122 and a gear part 124. The main part 122 is utilized for holding the signal processing circuit 121. The positioning component 18 comprises a positioning gear 182, an elastic component 184 and a circular slice 186. The elastic component 184 provides an elastic force towards a direction D4 to push the positioning gear 182 to connect with the gear part 124. When the signal transceiving component 12 rotates on the axle A1, the gear part 124 pushes the positioning gear 182 to move towards a direction D3 to repress the elastic component 184. Also, when the signal transceiving component 12 rotates by a predetermined angle, the elastic component 184 returns to the original state and provides an elastic force to push the positioning gear 182 to move towards the direction D4 to connect with the gear part 124 again, so that the rotation angle of the signal transceiving component 12 can be limited. Moreover, the positioning gear 182 comprises a plurality of slots 192 and 194 to fix the positioning gear 182 on the hinge part 144 shown in FIG. 2. Therefore, when the signal transceiving component 12 rotates on the axle A1, the positioning gear 182 does not rotate accordingly. After the positioning gear 182 and the elastic component 184 are placed in the hinge part 144 shown in FIG. 1, the circular slice 186 fixed on the hinge part 144 is utilized for preventing the positioning gear 182 and the elastic component 184 from sliding out of the hinge part 144.

It should be noted that in the present invention, the signal transceiving component 12 and the positioning component 18 connected to the signal transceiving component 12 are not limited to the forms utilized in the above-mentioned embodiment. For example, either the gear part 124 in the signal transceiving component or the positioning gear 182 can be replaced by a wedge. The elastic component can alternatively be installed between the main part 122 and the gear part 124 of the signal transceiving component. The above-mentioned implementations can also achieve the goal of making the signal transceiving component rotate on the axle A1. In addition, each of the elastic components 164 and 184 in the present embodiment is a spring; however, the equivalent implementations using other elastic materials/objects are also covered by the present invention.

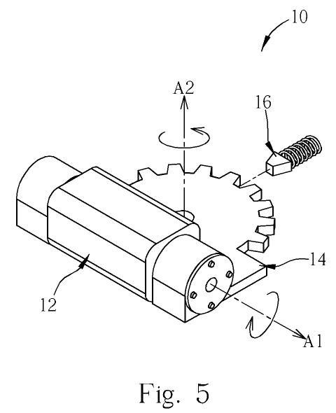

Please refer to FIG. 5. FIG. 5 is an exterior view diagram of the fabricated transceiving apparatus 10 according to the present invention. The fabricated signal transceiving component 12 can rotate on the axle A1 relative to the holder. Also, the signal transceiving component and the holder 14 can rotate on the axle A2. In this way, the transceiving apparatus 10 according to the present invention can adjust the transceiving direction according to a position of another transceiving apparatus, so that the signal transceiving quality can be further improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A transceiving apparatus capable of adjusting a transceiving direction, comprising:
a signal transceiving component for transmitting or receiving a signal; and
a holder connected to an electronic device in a rotatable position, wherein the signal transceiving component is installed in the holder.

2. The transceiving apparatus of claim 1, wherein the transceiving apparatus further comprises a positioning component connected to the electronic device, and the holder comprises:
a hinge part, wherein the signal transceiving component is installed on the hinge part in a rotatable position; and
a gear part connected to the positioning component in a rotatable position.

3. The transceiving apparatus of claim 2, wherein the positioning component further comprises:
a wedge coupled to the gear part; and
an elastic component connected to the wedge for providing an elastic force to push the wedge towards a first direction to connect with the gear part;
wherein when the signal transceiving component rotates, the gear part pushes the wedge to move in a second direction.

4. The transceiving apparatus of claim 3, wherein the elastic component is a spring.

5. The transceiving apparatus of claim 1, wherein the signal transceiving component is an infrared ray (IR) module, and the signal is an IR signal.

6. A connecting device, comprising:
a signal transceiving component for transmitting or receiving a signal;
a first positioning component, wherein the signal transceiving component is connected to the first positioning component in a rotatable position; and
a holder connected to an electronic device in a rotatable position, wherein the signal transceiving component and the first positioning component are installed in the holder.

7. The connecting apparatus of claim 6, wherein the connecting apparatus further comprises a second positioning component, and the holder comprises:
a hinge part for fixing the signal transceiving component and the first positioning component; and
a first gear part connected to the second positioning component in a rotatable position.

8. The connecting apparatus of claim 7, wherein the second positioning component further comprises:
a wedge coupled to the first gear part; and
a first elastic component connected to the wedge for providing an elastic force to push the wedge towards a first direction to connect with the first gear part;
wherein when the signal transceiving component rotates, the first gear part pushes the wedge to move in a second direction.

9. The connecting apparatus of claim 8, wherein the first elastic component is a spring.

10. The connecting apparatus of claim 6, wherein the signal transceiving component comprises:
a main part for holding a signal processing circuit utilized for transmitting or receiving the signal; and
a second gear part being fixed on the main part for connecting the signal transceiving component to the first positioning component in a rotatable position.

11. The connecting apparatus of claim 10, wherein the first positioning component comprises:
a positioning gear; and
a second elastic component coupled to the positioning gear for providing an elastic force to push the positioning gear towards a first direction to connect with the second gear part;
wherein when the signal transceiving component rotates, the second gear part pushes the positioning gear to move in a second direction.

12. The connecting apparatus of claim 11, wherein the second elastic component is a spring.

13. The connecting apparatus of claim 11, wherein the second gear part and the positioning gear share an axle center.

14. The connecting apparatus of claim 6, wherein the signal transceiving component is an IR module, and the signal is an IR signal.

15. An electronic device, comprising:
a housing;
a signal transceiving component for transmitting or receiving a signal; and
a holder connected to the housing in a rotatable position, wherein the signal transceiving component is installed in the holder.

16. The electronic device of claim 15, wherein the holder comprises:
a hinge part, wherein the signal transceiving component is installed on the hinge part in a rotatable position; and
a gear part connected to a positioning component of the housing in a rotatable position.

17. The electronic device of claim 16, wherein the positioning component further comprises:
a wedge coupled to the gear part; and
an elastic component connected to the wedge for providing an elastic force to push the wedge towards a first direction to connect with the gear part;
wherein when the signal transceiving component rotates, the gear part pushes the wedge to move in a second direction.

18. The electronic device of claim 17, wherein the elastic component is a spring.

19. The electronic device of claim 15, wherein the signal transceiving component is an IR module, and the signal is an IR signal.
